(19) United States
(12) Patent Application Publication
(10) Pub. No.: US 2012/0164450 A1
(43) Pub. Date: Jun. 28, 2012

(54) METHOD FOR PRODUCING AND TREATING NANOSIZED DOPED ZINC OXIDE PARTICLES

(75) Inventors: Victor A. SOLOUKHIN, Geldrop (NL); Gerard VAN BEMMEL, Enschede (NL)

(73) Assignee: OCE-TECHNOLOGIES B.V., Venlo (NL)

(21) Appl. No.: 13/345,358

(22) Filed: Jan. 6, 2012

Related U.S. Application Data
(63) Continuation of application No. PCT/EP2010/059121, filed on Jun. 28, 2010.

(30) Foreign Application Priority Data
Jul. 8, 2009 (EP) 09164895.6
Jul. 10, 2009 (EP) 09165158.8

(51) Int. Cl. B32B 5/16; H01B 1/02; B82Y 40/00; B82Y 30/00

(52) U.S. Cl. 428/402; 252/512; 977/895; 977/773

(57) ABSTRACT

A method is provided for treating nanosized doped zinc oxide particles and a method is provided for producing nanosized doped zinc oxide particles, preferably to be treated according to the method for treating. Nanosized doped zinc oxide particles are obtained and/or treated by the method(s) of treating and producing. A toner includes the nanosized doped zinc oxide particles.

### CROSS-REFERENCE TO RELATED APPLICATIONS

This application is a Continuation of PCT International Application No. PCT/EP2010/059121 filed on Jun. 28, 2010, which claims priority benefit of Patent Application Nos. 09164895.6 filed in European Patent Office, on Jul. 8, 2009 and 09165158.8 filed in European Patent Office, on Jul. 10, 2009. The entire contents of all of the above applications are hereby incorporated by reference.

### BACKGROUND OF THE INVENTION

1. Field of the Invention

The invention relates to a method for treating nanosized doped zinc oxide particles. The invention also relates to a method for producing nanosized doped zinc oxide particles preferably to be treated according to the latter method. The invention further relates to nanosized doped zinc oxide particles obtained and/or treated by the method(s) according to the invention. The invention moreover relates to toner comprising said nanosized doped zinc oxide particles.

2. Description of Background Art

In recent years the number of applications in which transparent (semi-)conductive oxides are used, such as toner materials and liquid crystal displays (LCD's), are used has increased considerably. Because of the immense market for LCD's research and development in the technical field of transparent conductive oxides is unlikely to halt in the near future. In theory, several metal oxides will fulfil the minimum requirements of transparency and conductivity. There exists, for example, conductive antimony-doped-tin oxide; however antimony will not likely be used on a large scale as it has its environmental and toxic drawbacks. In present and future technological applications highly specialized functional materials with a right set of mechanical, electrical, optical, morphological, environmental-friendly properties, and competing cost price are needed. Matching these properties is often conflicting, and poses a challenge to the development of these materials. To this end, it has been found that doped zinc oxide has a balanced set of properties to provide a quite satisfying transparent conductive oxide, since zinc oxide is, unlike many of the materials with which it competes, relatively inexpensive, relatively abundant, chemically stable, easy to produce and non-toxic. Although in theory, zinc oxide particles should in addition to these properties also have a relatively high conductivity in theory, it has, however, been found that in practice the conductivity of doped zinc oxide particles is relatively poor and unfortunately restricted to about 10⁻⁷-10⁻⁸ S/cm (Siemens per centimetre), which affects the applicability of doped zinc oxide as transparent conductive oxide.

### SUMMARY OF THE INVENTION

It is an object to the invention to provide a method for treating doped zinc oxide particles in order to increase the conductivity of said particles.

This object can be achieved by providing a method according to the preamble, comprising the steps of: A) providing zinc oxide particles doped with at least one dopant selected from the group consisting of: aluminium, gallium, and indium, typically in the amount of up to 5 mole percent, and B) exposing said doped zinc oxide particles to at least one reducing substance. It has surprisingly be found that a post treatment of the synthesized doped nanosized zinc oxide particles with at least one reducing substance has a remarkable positive effect on the electrical conductivity of the material; Namely, the conductivity of the aluminium, gallium, and/or indium doped zinc oxide particles has increased significantly with a factor in the order of 10⁴-10⁵ after such a post treatment. The increased conductivity of the doped zinc oxide particles considerably expands the applicability of the doped zinc oxide particles as a transparent conductive oxide in various applications, among which toner materials and flat panel displays, such as LCD's. Although the mechanism of reduction of the doped zinc oxide particles leading to the considerably improved conductivity is not completely clear at present, it is believed that under reducing atmosphere a substantial part of the remaining impurities that reacted with the doped zinc particles during synthesis are removed resulting in an improved surface conductivity of the particles as such and hence in an improved overall conductivity. The exact nature of these impurities is not totally clear at this point. In this context it is noted that nanosized particles are defined as dispersible particles having two or three dimensions greater than 1 nm and less than about 100 nm, as will be known and recognized by the person skilled in the art. It is further noted that providing the doped zinc oxide particles according to step A) could imply either obtaining (buying) commercially available suitable doped zinc oxide particles or (self) synthesizing doped zinc oxide particles, preferably by applying to the production method according to the present invention.

Although different types (structures) of doped zinc oxide particles are commercially available, at least most of the available types are regrettably not suitable to be treated according to the method of the invention as described above. Therefore, it is a further object of the invention to provide a method for producing nanosized doped zinc oxide particles suitable to be treated according to the post treatment method of the invention as described in the above.

In an embodiment of the method according to the present invention, step A) comprises the steps of:
(i) preparing an aqueous solution comprising zinc particles, dopant particles, and a stabilizing agent, said dopant particles comprising dopant elements selected from the group consisting of: aluminium, gallium, and indium,
(ii) heating said aqueous solution thereby forming a solution gel, and
(iii) decomposing said solution gel at further increased temperature of between 380 and 450 degrees Celsius thereby forming nanosized doped zinc oxide particles.

Hereinafter, step (iii) may also be referred to as a calcination step.

During step (i) an aqueous solution is prepared comprising zinc particles, dopant particles, and a stabilizing agent. Said aqueous solution is prepared by dissolving the zinc particles, dopant particles and the stabilizing agent. Said zinc particles may be any solid ingredient comprising element zinc, such as a zinc salt or a zinc complex, which zinc particle is soluble in water or any other aqueous solvent mixture at a sufficient level. Said dopant particles may be any solid ingredient comprising a dopant element selected from the group consisting of: aluminium, gallium, and indium. Said dopant particles are soluble in water or any other aqueous solvent mixture at a sufficient level.

Said stabilizing agent acts to stabilize and coordinate both the dissolved zinc component and the dissolved dopant component. In particular the stabilizing agent may provide non-covalent interactions with the zinc and dopant elements in the aqueous solution, thereby providing a stable mixture of both elements during the gelation formation phase carried out in step (ii). As a result of stabilising the gelation forming phase, phase separation of the gel, e.g. into ZnO and Al₂O₃, and/or formation of needle-shaped crystals is reduced. In this way nanosized doped particles may be obtained during the calcination step (iii) from the stabilised gel phase, said particles having an appropriate particle size, crystal phase and homogenous dopant level.

Various organic stabilizing agents may be used as stabilizing agents. In an embodiment, citric acid is used as stabilizing agent. Using citric acid a stable and homogenous gel is obtained. In an particular embodiment the ratio between molar amount of the citric acid and the sum of the molar amounts of Zn and the molar amount of dopant atoms in the solution is in the range of 0.9 to 1.5. In case the ratio becomes lower than about 0.9 the gel during the gel formation step (ii) may become less stable. In case the ratio becomes higher than about 1.5 it may become more difficult to decompose the organic material in the gel during the calcination step (iii). In a further embodiment the ratio is about 1.0.

During step (iii), wherein calcination takes place, the temperature is preferably gradually, more preferably with a heating rate not exceeding 15 degrees Celsius per minute, increased to the temperature of between 380 and 450 degrees Celsius.

The calcination process according to step (iii) takes place in an oxygen containing atmosphere at a temperature between 380 degree Celsius and 450 degree Celsius to promote decomposition of the organic part of the gel by oxidation. To this end, an environment of purified dry air will commonly be satisfying. The environment of substantially pure oxygen will commonly be undesired due to explosion risks. In an embodiment, in case the formed doped zinc oxide particles are not (directly) subjected to the post treatment method according to the invention, the formed particles are cooled down by means of nitrogen.

During step (iii), in presence of oxygen, decomposition reactions start to occur and organic species, such as CO₂ and NO, are removed. In particular in step (iii) the organic components in the gel, such as an organic stabilizing agent, is decomposed and thereby carbon elements may be removed from the gel phase.

A too high calcination temperature, typically above 500 degree Celsius, may result in the formation of too large particles and/or needle-shaped particles, and is likely to cause a phase separation, e.g. into ZnO and Al₂O₃. At a too low calcination temperatures, typically below 380 degree Celsius it may become difficult to remove organic residues in the particles. As a result the organic residue in the particles may disturb the crystal phase of the doped ZnO particles and the electrical conductive property of the particles, which may be obtained during step B).

In step (iii) a porous structure (e.g. a foam-like structure) comprising doped zinc oxide nanaoparticles are fanned. The form of said nanoparticles in said structure may be substantially spherical, and said nanoparticles may have an average particle size of less than 30 nm.

During step B) the doped zinc oxide particles are preferably exposed to at least one gaseous reducing substance, preferably hydrogen. In order to make the reduction process more efficient it is commonly preferable to apply an increased temperature (temperature higher than room temperature). Thermogravimetric analysis (TGA) and mass spectrometry (MS) of several samples has revealed that almost all water is removed at temperature (slightly) less than 300 degrees Celsius and that CO₂ (and possibly other decomposition gases) leaves the doped zinc oxide particles at a temperature of about 420 degrees Celsius. It may therefore be preferable that the doped zinc oxide particles are subjected to an environmental temperature of at least 300 degree Celsius, more preferably at about 450 degree Celsius, prior to and/or during exposure of the doped zinc oxide particles to at least one reducing substance. In this manner, water, and more preferably also the (other) decomposition gases can be removed from the doped zinc oxide particles in order to further improve the reduction process of the zinc oxide particles. In a particular preferred embodiment the environmental temperature will be gradually increased to said at least 300 degree Celsius, preferably said at about 450 degree Celsius, prior to and/or during step B). A gradual increase of temperature, preferably with a heating rate of between 5 and 15 degrees Celsius per minute, will prevent phase separation of the doped zinc oxide particles into zinc oxide and the dopant oxide.

In an embodiment the method further comprises step C) between steps A) and B), in which step C)the doped zinc oxide particles are subjected to a substantially inert atmosphere, such as a nitrogen or argon atmosphere, prior to exposing said doped zinc oxide particles to at least one reducing substance according to step B). In this manner chemical reactions between atmospheric compounds and the reducing substance can be counteracted, as a result of which the reducing substance will be employed as effectively as possible.

In order to increase the mutual contact of the reducing substance and the doped zinc oxide particles, it may be favourable to keep the doped zinc oxide particles in motion during step B). Motion can for example be established by means of a stirring means and/or by means of subjecting the particles to fluidisation. In case the doped zinc oxide particles are substantially connected to each other as to form a, commonly porous, structure of nanosized doped zinc oxide particles, it will often not be possible to keep the particles in motion. However, since the nanosized structure will commonly be porous, there is commonly no need to keep the particles in motion, since substantially all particles can be brought into sufficient contact with the reducing substance by leading the reducing substance through the nanosized structure.

In an embodiment, during step B) a quantity of doped zinc oxide particles is exposed to an excess of the at least one reducing substance in order to further improve the reducing effect of the reducing substance. In case gaseous hydrogen (H₂) is used as reducing substance, the doped zinc oxide particles are preferably positioned in a reduction compartment in which the hydrogen is led, preferably with a predetermined flow rate of, for example, several millilitres per minute.

It has been found that the pH of the aqueous solution has an influence on the stability of the solution gel (sol-gel) formed during step (ii). Therefore, during step (i) the aqueous solution preferably further comprises a pH adjusting substance, such as aqueous ammonia. Preferably the pH is kept at about 6,5, though more generic within the range of between 4 and 9.

In an embodiment step (ii), wherein gelation takes place, is at least partially performed at a temperature of between 50 and 70 degrees Celsius in order to speed up evaporation of water from the aqueous solution to form the solution gel. The gelation commonly takes up to several hours. In case the calcination process according to step (iii) is not immediately performed after the completion of the gelation process according to step (ii), it is preferred to conserve the solution gel formed in a substantially inert environment, such as a nitrogen or argon atmosphere or a vacuum, to prevent the gel from absorbing atmospheric water which would deteriorate the gel structure and which would consequently affect the calcination process according to step (iii).

By applying the synthesis method according to the invention, commonly a, typically white or slightly yellowish, porous structure comprising nanosized doped zinc oxide particles is formed. As mentioned above, this porous structure is commonly appropriate to be subjected to a reducing substance according to the post treatment method according to the invention. However, in case individual, loose (separate) doped zinc oxide particles are desired, the method preferably further comprises step (iv) comprising pulverizing the doped zinc oxide particles formed during step (iii). Pulverizing the doped zinc oxide particles can be established, for example, by mechanical and/or vibration milling This pulverizing process will commonly be in a dry mode and at room temperature.

The invention further relates to nanosized doped zinc oxide particles obtained by the synthesis method according to the invention. The synthesized nanosized doped zinc oxide particles are nanosized (typically up to 30 nm in size), substantially transparent, uniform, and randomly oriented. In particular it has been found, e.g. from XRD data and EDX data, that in said nanosized doped zinc oxide particles 1) the crystals have substantially a wurtzite phase and 2) the ratio between the molar amount of element oxygen and the sum of the molar amount of the element zinc and the molar amount of the at least one dopant element, e.g. Gallium, Aluminium and/or Indium, is about 1.

The nanosized particles, preferably synthesized by the production method according to the invention, are more preferably treated by the post treatment method according to the invention, as a result of which the color of said nanosized particles becomes (light) grey. As a result of said post treatment method said doped zinc oxide particles have a minimum conductivity of 10⁻³ Siemens per centimetre. This relatively high degree of conductivity remains stable over time, commonly at least for several months, and therefore further improves the set of properties of the doped zinc oxide particles to act as transparent conductive oxide in various applications.

The invention moreover relates to toner comprising said nanosized doped zinc oxide particles. Commonly the zinc oxide particles may form a relatively hard and antistatic coating around toner particles to prevent mutual sticking of toner particles. Said nanosized doped zinc oxide particles may also be dispersed in the toner.

By application of the nanosized doped zinc oxide particles in the toner and/or on the surface of the toner, the electrical conductivity of said toner may be adjusted. Application of the nanosized doped zinc oxide particles in toner has the advantage that a transparant or coloured electrical conductive toner may be obtained, which is suitable for electrostatic image development.

### BRIEF DESCRIPTION OF TEE DRAWINGS

The present invention will become more fully understood from the detailed description given hereinbelow and the accompanying drawings which are given by way of illustration only, and thus are not limitative of the present invention, and wherein:

FIG. 1 is an illustration of an example of a production method according to the present invention; and

FIG. 2 is a chart illustrating a typical conductivity of different commercial doped and undoped ZnO nanoparticles.

### DETAILED DESCRIPTION OF THE PREFERRED EMBODIMENTS

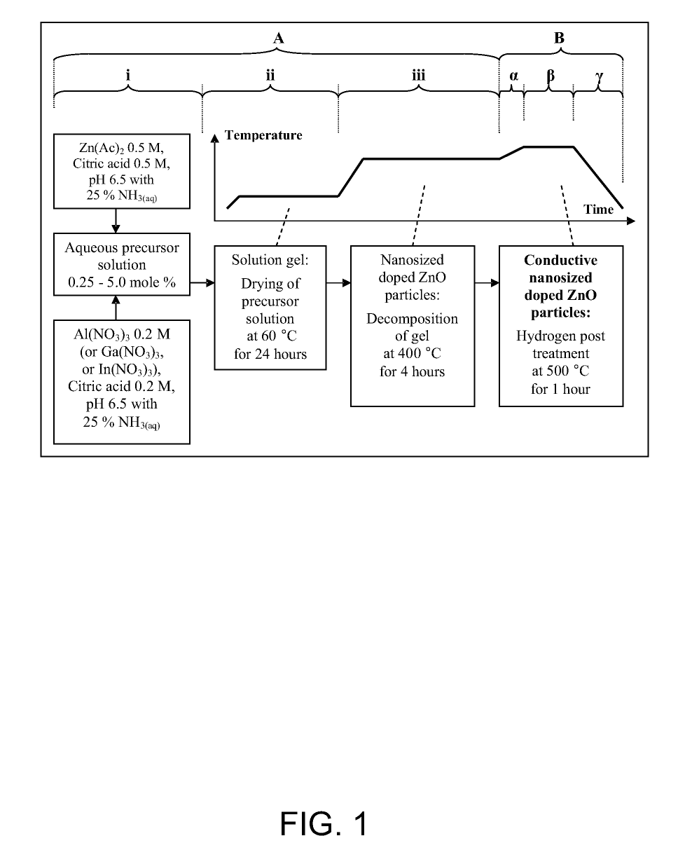

A non-limitative illustrative example of the production method according to the invention and a subsequent post treatment method according to the invention is given below, wherein reference is made to the accompanying overview as shown in FIG. 1. In FIG. 1 the steps (i), (ii), and (iii) for producing nanosized doped zinc oxide particles are shown, this total production process being indicated as step A. The subsequent post treatment process is indicated as step B in FIG. 1.

### Example

Step A(i): Preparation of an Aqueous Precursor Solution

Zinc acetate dihydrate (Zn(CH₃COO)₂·2H₂O=Zn(Ac)₂) was used as the zinc source. Citric acid acted as a stabilizing and coordinating agent. 54.88 gram (0.25 moles) of zinc acetate dihydrate was weighed and dissolved in 500 ml of deionized water. To this, 48.03 gram (0.25 moles) of citric acid was added and stirred into a solution. This resulted in a 0.5 M stock Zn(Ac)₂/Citric acid solution. 46.89 gram (0.125 mole) of aluminium nitrate nonahydrate (Al(NO₃)₃·9H₂O) and 24.02 gram (0.125 mole) citric acid was weighed and dissolved in 625 ml of deionized water. This resulted in a 0.2 M stock Al(NO₃)₃/Citric acid solution. A 0.2 M stock Ga(NO₃)₃/Citric acid solution was prepared in the same way as the aluminium containing stock solution. The pH of the zinc, aluminium and gallium containing solutions was increased to pH=6.5 or 8.5 by carefully adding ammonia solution (NH_{3(aq)}), saturated at 25 mass percent. In accordance with the desired dopant content, the aqueous stock solutions containing zinc and aluminium or gallium, and having the same pH, were mixed together in proportions indicated in Table 1. The latter resulted in aqueous precursor solutions suitable for further production steps according to the invention.

TABLE 1
Preparation of aqueous precursor solutions for three samples.

| | Dopant | Zn(Ac)₂/ | Al(NO₃)₃/ | Ga(NO₃)₃/ | |
|---|---|---|---|---|---|
| Sample | content | Citric acid | Citric acid | Citric acid | pH |
| S1 | 2 mole % Al | 50 ml | 2.5 ml | — | 6.5 |
| S2 | 2 mole % Al | 50 ml | 2.5 ml | — | 8.5 |
| S3 | 4 mole % Ga | 50 ml | — | 5.0 ml | 6.5 |

Step A(ii): Gelation of the Aqueous Precursor Solutions

Each precursor solution was poured in an alumina boat (crucible) in the amount of 10 ml. Alumina boats had the following dimensions: length −7.5 cm, width −3.0 cm and height −1.5 cm. During the subsequent gelation process the precursor solutions were kept at a gelation temperature of 60° C. during 24 hours. See also FIG. 1. The obtained gels still could be handled very much like a hair gel.

Gelation and subsequent calcination should be preferably performed within the same vessel, e.g. an alumina boat. Otherwise during a material transfer from one vessel to another, e.g. from a glass beaker to an alumina boat, a phase transition from gel-like to crystalline can be provoked. Cooling down of a gel also increases a risk for pernicious crystal formation. The amount of gel in a crucible (per crucible's surface area) should be low. It if it is too large, an exothermal step, which takes place during calcination, will cause local overheating, which subsequently can lead to a phase separation, e.g. into ZnO and Al₂O₃, and/or formation of needle-shaped crystals.

Step A(iii): Calcination of the Gels Leading to Nanosized Doped ZnO Particles

Starting from the gels formed during step A(ii) and containing both organic ions and metal ions, the calcination process of gels goes through several stages in general. At a relatively low temperature mostly evaporation of water, NH₃ and CH₃COOH takes place. At much higher temperatures, in presence of oxygen, decomposition reactions start to occur and organic species, such as CO₂ and NO, are removed. When gels are subjected to a too high temperature (approximately 500° C.), a rapid formation of crystals with needle-like shape was observed. Phase separation of a dopant oxide, e.g. aluminium oxide (Al₂O₃), from the ZnO wurtzite phase is also expected when doped ZnO is subjected to a too high temperature, in particular for a long period of time. Hence, such a high temperature would negatively affect the calcination process and is therefore not preferable.

In the last stage of nanoparticles formation, excessive carbon is oxidized. This step is rather exothermic. Temperature measured above the sample is less than the actual temperature inside the sample material. It is possible that because of local overheating the needle-like crystals are formed. Therefore, a care must be taken to let the oxidation take place more gradually, preventing the exothermic spike. Apparently that at relatively low temperatures, a longer isothermal step will be needed to remove excessive carbon as compared to a sudden exothermic reaction. In an effort to prevent the sudden exothermic step, in the preliminary experiments, the calcination of the gels was also carried out at a very low temperature, as low as 350 ° C. It was found that calcination at such temperatures conflicts with removal of carbon residues from the sample material. Because of this calcination at such low temperatures was not considered to be a viable option to produce a good material, as organic residues remain even after prolonged calcination duration.

The calcination process can be performed best at a temperature between 380 and 450° C. In this example, in order to form small spherically shaped particles, the calcination temperature of approximately 400° C. was used. For the same purpose, the heating rate of 10° C/min was used and the isothermal step lasted for 4 hours (step A(iii) in FIG. 1). An air flow in a tubular calcination oven was kept low in order to prevent large temperature gradients. For the same purpose a stainless steel mesh, which acted as a heat exchanger and was positioned before the boats, was employed. In the present example a gradient of 5° C. over 3.5 cm, the inner radius of the tubular calcination oven, was measured. On the other hand, the air flow should be high enough to provide enough oxygen for decomposition of organics and for removal of gaseous products. The most preferable air flow rate commonly depends on geometry of the calcination oven used. In this example, a flow rate of 0.5 l/min was used.

Step B: Post Treatment of the Nanosized Doped Zinc Oxide Particles

Afterwards, the three samples (Table 1) were post annealed in a reducing atmosphere to remove any remaining impurities after the calcination step. The exact nature of these impurities is not clear at this point. It is thought, though, that for example the last remaining hydroxyl groups can be removed during this post treatment.

For practical reasons, the hydrogen treatment of these samples was conducted in a TGA setup. Samples were heated to 500° C. in N₂ at a heating rate of 10° C/min (step B(a)), followed by a reducing treatment for 1 hour under pure H₂ , 50 ml/min, also at 500 ° C. (step B((β)). Hydrogen was also used during cooling down to 50° C. (step B(γ)). The TGA setup was cooled down to room temperature and flushed with N₂ for a few minutes for safety reasons.

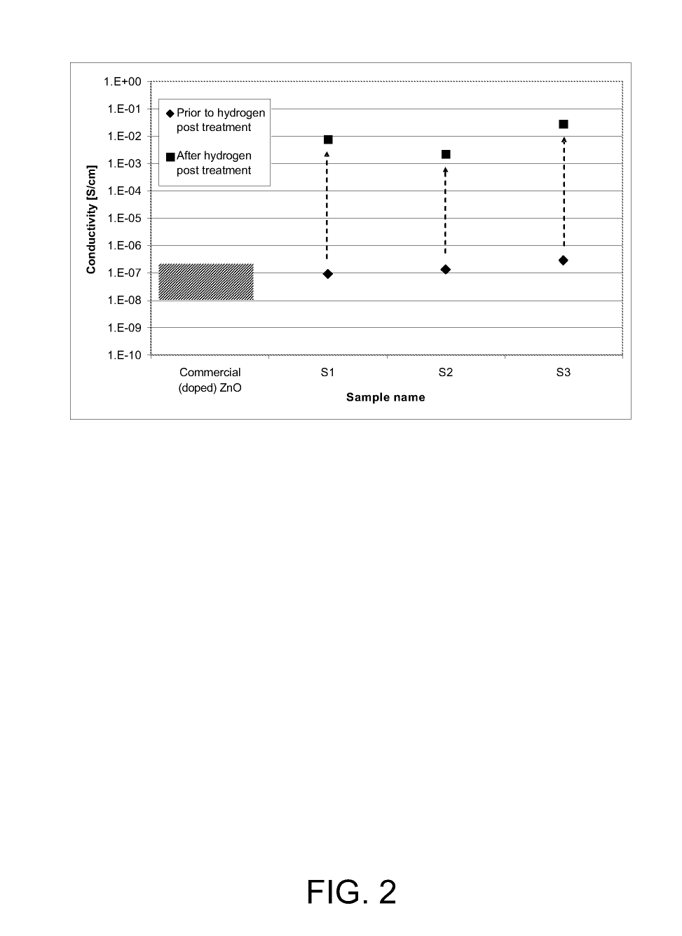

As a theoretical background it is noticed that conductivity is the ability of a material to conduct electrical current. It is the reciprocal of resistivity. Both measures are used throughout literature and this can be confusing when one does not pay attention to the units of these physical quantities. Conductivity (σ) is expressed in [S·cm⁻¹] whereas resistivity (ρ) is expressed in [Ω·cm ]. Conductivity of the synthesized nanoparticles was tested by pressing powder between two cylindrical electrodes and measuring the electrical resistance. The aluminium doped zinc oxide nanoparticles were compacted into a tablet by placing a constant mass on top of the measuring electrodes. The conductivity was calculated by taking into account the measured resistance and distance between the electrodes and geometry of the measuring setup. SEM photographs were used to determine the particle size. The determined values for particle sizes, resistivity and conductivity of the described samples are shown in Table 2 below. The conductivity of the samples is graphically shown in FIG. 2.

TABLE 2
Particle size, resistivity and conductivity of the
samples prior and after hydrogen post treatment.

| | | Particle size | Prior to H₂ post treatment | | After H₂ post treatment | |
|---|---|---|---|---|---|---|
| | | (small-middle- | ρ | σ | ρ | σ |
| | Dopant | large) | resistivity | conductivity | resistivity | conductivity |
| Sample | content | [nm] | [Ω · cm] | [S/cm] | [Ω · cm] | [S/cm] |
| S1 | 2 mole % | 22-27-54 | 1.08 · 10⁷ | 9.27 · 10⁻⁸ | 1.26 · 10² | 7.96 · 10⁻³ |
| | Al | | | | | |
| S2 | 2 mole % | 14-15-21 | 7.15 · 10⁶ | 1.40 · 10⁻⁷ | 4.17 · 10² | 2.40 · 10⁻³ |
| | Al | | | | | |
| S3 | 4 mole % | 16-18-27 | 3.43 · 10⁶ | 2.91 · 10⁻⁷ | 3.47 · 10¹ | 2.88 · 10⁻² |
| | Ga | | | | | |

Typical conductivity of different commercial doped and undoped ZnO nanoparticles is also shown in FIG. 2. As can be seen in the figure, the conductivity values of commercial (doped) ZnO forms a wide range rather than a single value. As can be seen both in Table 2 and in FIG. 2, the samples post treated with hydrogen exhibit a substantial increase in conductivity, and, hence, a significant decrease in resistivity, in the order of magnitude of 10⁴-10⁵.

It is noticed that the experiment performed and described above is considered far from being an optimized process, so results are very likely to improve with tuning of the process parameters and equipment. There are no obvious fundamental bottlenecks that can prevent scaling up of the process in an economical way. This means that the economic production of electrically conductive nanosized doped zinc oxide nanoparticles should be feasible when practical solutions are developed for scaling up the synthesis route.

It should be noted that the above-mentioned embodiments illustrate rather than limit the invention, and that those skilled in the art will be able to design many alternative embodiments without departing from the scope of the appended claims. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Method for treating nanosized doped zinc oxide particles, comprising the steps of:
A) providing zinc oxide particles doped with at least one dopant selected from the group consisting of: aluminium, gallium, and indium, and
B) exposing said doped zinc oxide particles to at least one reducing substance.
wherein step A) comprises the steps of:
(i) preparing an aqueous solution by dissolving zinc particles, dopant particles, and a stabilizing agent, said dopant particles comprising dopant elements selected from the group consisting of: aluminium, gallium, and indium,
(ii) heating said aqueous solution, thereby forming a solution gel, and
(iii) decomposing said solution gel at further increased temperature of between 380 and 450 degrees Celsius, thereby forming nanosized doped zinc oxide particles.

2. Method according to claim 1, wherein the stabilizing agent is an organic stabilizing agent, in particular the organic stabilizing agent may be citric acid.

3. Method according to claim 2, wherein the organic stabilizing agent is citric acid and wherein in step (i) and (ii) of step A) the ratio between molar amount of the citric acid and the sum of the molar amount of Zn and the molar amount of dopant atoms in the solution is in the range of 0.9 to 1.5.

4. Method according to claim 2, wherein during step (iii) of step A) the organic stabilizing agent in said solution gel is decomposed in the presence of oxygen thereby forming gaseous products and said formed gaseous products are removed from the solution gel.

5. Method according to claim 1, wherein the nanosized doped zinc oxide particles are substantially spherical and have an average particle size of less than 30 nm.

6. Method according to claim 1, wherein during step B) the doped zinc oxide particles are exposed to at least one gaseous reducing substance, preferably hydrogen.

7. Method according to claim 1, wherein the doped zinc oxide particles are subjected to an environmental temperature of at least 300 degree Celsius, prior to and/or during step B) exposure of the doped zinc oxide particles to at least one reducing substance.

8. Method according to claim 7, wherein prior to and/or during step B) the environmental temperature will be gradually increased to said at least 300 degree Celsius.

9. Method according to claim 1, wherein during step (iii) the temperature is gradually, preferably with a heating rate not exceeding 15 degrees Celsius per minute, increased to the temperature of between 380 and 450 degrees Celsius.

10. Method according to claim 1, wherein during step (i) the pH of the aqueous solution is kept in a range of between 4 and 9, in particular the aqueous solution further comprises a pH adjusting substance.

11. Method according to claim 1, wherein step (ii) is at least partially performed at a temperature of between 50 and 70 degrees Celsius.

12. Method according to claim 1, wherein the doped zinc oxide particles comprises up to 5 mole percent dopant.

13. Doped nanosized zinc oxide particles obtainable by the method according to claim 1, wherein the doped nanosized zinc oxide particles are up to 30 nm in size and wherein said doped zinc oxide particles having a conductivity of at least 10⁻³ Siemens per centimetre.

14. Doped nanosized zinc oxide particles obtainable by the method according to claim 1, wherein said particles have a wurtzite phase.

15. Doped nanosized zinc oxide particles obtainable by the method according to claim 1, wherein the ratio between the molar amount of element oxygen and the sum of the molar amount of the element zinc and the molar amount of the at least one dopant element is about 1.

16. Method according to claim 3, wherein during step (iii) of step A) the organic stabilizing agent in said solution gel is decomposed in the presence of oxygen thereby forming gaseous products and said formed gaseous products are removed from the solution gel.

17. Method according to claim 2, wherein the nanosized doped zinc oxide particles are substantially spherical and have an average particle size of less than 30 nm.

18. Method according to claim 3, wherein the nanosized doped zinc oxide particles are substantially spherical and have an average particle size of less than 30 nm.

19. Method according to claim 4, wherein the nanosized doped zinc oxide particles are substantially spherical and have an average particle size of less than 30 nm.

20. Method according to claim 2, characterized in that during step B) the doped zinc oxide particles are exposed to at least one gaseous reducing substance, preferably hydrogen.
